(19) United States
(12) Patent Application Publication
(10) Pub. No.: US 2001/0008483 A1
(43) Pub. Date: Jul. 19, 2001

(54) Single module system for electric/electronic appliance

(76) Inventors: Sang-Kyun Lee, Kyounggi-do (KR); Jae-Chun Lee, Seoul (KR); Min-Kyu Hwang, Kyounggi-do (KR)

Correspondence Address: BIRCH STEWART KOLASCH & BIRCH, PO BOX 747, FALLS CHURCH, VA, 22040-0747, US

(21) Appl. No.: 09/725,105

(22) Filed: Nov. 29, 2000

(30) Foreign Application Priority Data
Jan. 19, 2000 (KR) 2445/2000

(51) Int. Cl. H01R 12/16

(52) U.S. Cl. 361/790

(57) ABSTRACT

Disclosed is a single module system for an electric/electronic appliance. The single module system comprises a first module section having a first PCB which is made of a ceramic or metal-based material and exothermic devices which are located on the first PCB; and a second module section having a second PCB which is made of an epoxy or phenol-based material and non-exothermic devices which are located on the second PCB.

### BACKGROUND OF THE INVENTION

1. Field of the Invention

The present invention relates to a single module system for an electric/electronic appliance, and more particularly, the present invention relates to a single module system for an electric/electronic appliance, which modularizes all devices excluding an electrical mounting occupying a large space in the electric/electronic appliance employing an inverter, thereby reducing bulk of the electric/electronic appliance.

2. Description of the Related Art

FIG. 1 is a block diagram schematically illustrating a parts arrangement of an inverter for the conventional electric/electronic appliance.

Referring to FIG. 1, in the conventional inverter, all circuit parts are mounted on a printed circuit board (PCB) 10. The respective circuit parts have a configuration of a dual in-line package (DIP).

Among the circuit parts, exothermic devices such as a bridge diode (BD) 2, a switching mode power supply (SMPS) 5, a triac 4, an intelligent power module (IPM) 6, and so forth have attached thereto a heat sink.

The IPM 6 which constitutes an important part of the inverter, is a module which has embedded therein six insulated gate bipolar transistors (IGBTs), free wheeling diodes (FWDs), an IGBT driving circuit, and an IGBT protecting circuit for protecting the IGBTs from over-current, etc. The drawing reference numeral 7 represents a micom for controlling the entire inverter circuit.

The conventional inverter constructed as mentioned above receives AC power. AC power flows through a filter 1, and thereafter, is inverted into DC power through the BD 2 and smoothing capacitors (Caps) 3. The DC power is regulated to a desired voltage such as 5V, 15V, or the like through the SMPS 5. The triac 4 is used to drive an external load.

However, the conventional inverter suffers from defects in that, since all parts are mounted on the PCB 10, volume of the PCB 10 is increased and according to this, bulk of the electric/electronic appliance is also increased.

### SUMMARY OF THE INVENTION

Accordingly, the present invention has been made in an effort to solve the problems occurring in the related art, and an object of the present invention is to provide a single module system for an electric/electronic appliance, which modularizes all devices excluding an electrical mounting occupying a large space in the electric/electronic appliance employing an inverter, thereby reducing bulk of the electric/electronic appliance.

In order to achieve the above object, according to one aspect of the present invention, there is provided a single module system for an electric/electronic appliance, comprising: a first module section having a first PCB which is made of a ceramic or metal-based material and exothermic devices which are located on the first PCB; and a second module section having a second PCB which is made of an epoxy or phenol-based material and non-exothermic devices which are located on the second PCB.

According to another aspect of the present invention, the first module section and the second module section are structured in a manner such that the first and second PCBs are connected with each other through and supported by supporting bars.

According to still another aspect of the present invention, the devices for the single module system comprise bare type parts.

By the features of the present invention, all circuit parts which are mounted on a PCB of the conventional inverter, can be modularized in a manner such that exothermic devices and non-exothermic devices are separately located on first and second layers, respectively. In the present invention, the first layer is formed of a material having an excellent heat transfer characteristic, such as a ceramic or metal-based PCB, so as to facilitate dissipation of heat which is generated by the exothermic devices, and the second layer is composed of an epoxy or phenol-based PCB. In order to further reduce a size of a module, the exothermic and non-exothermic devices comprise bare type parts. As a result, by the present invention, advantages are provided in that it is possible to realize a single modularized segment for a circuit of an electric home appliance employing an inverter.

### BRIEF DESCRIPTION OF THE DRAWINGS

The above objects, and other features and advantages of the present invention will become more apparent after a reading of the following detailed description when taken in conjunction with the drawings, in which:

FIG. 1 is a block diagram schematically illustrating a parts arrangement of an inverter for the conventional electric/electronic appliance;

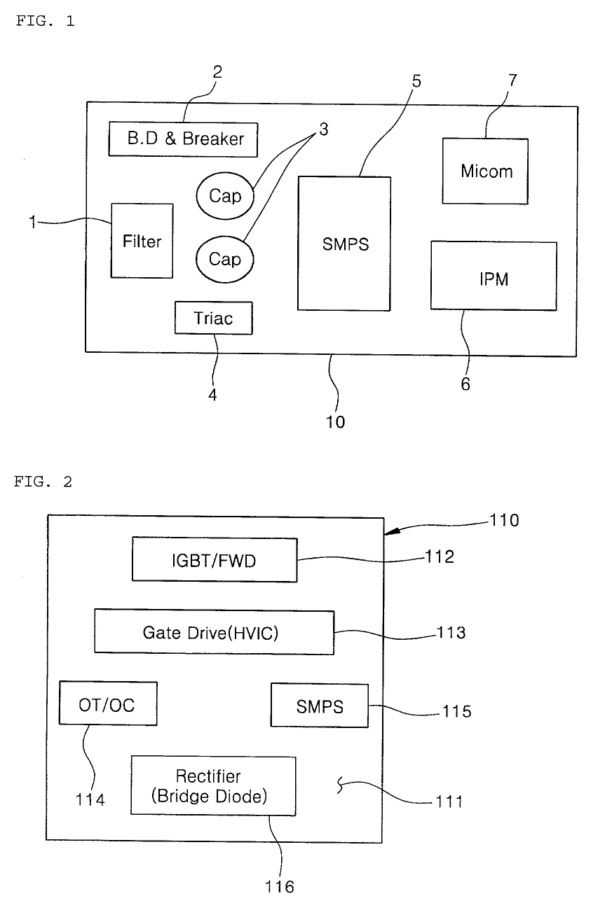

FIGS. 2 and 3 are block diagrams respectively illustrating a power board and a control board of a single module system for an electric/electronic appliance, in accordance with an embodiment of the present invention;

FIG. 4 is a cross-sectional view illustrating a double-layered arrangement of the power board and the control board of the single module system for an electric/electronic appliance according to the present invention;

FIGS. 5a through 5c are cross-sectional views illustrating a variety of connection patterns between the power board and the control board in the single module system for an electric/electronic appliance according to the present invention; and

FIGS. 6a through 6c are perspective views illustrating a diversity of configurations of outside-connecting pins which are formed on an outer surface of the single module system for an electric/electronic appliance according to the present invention.

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

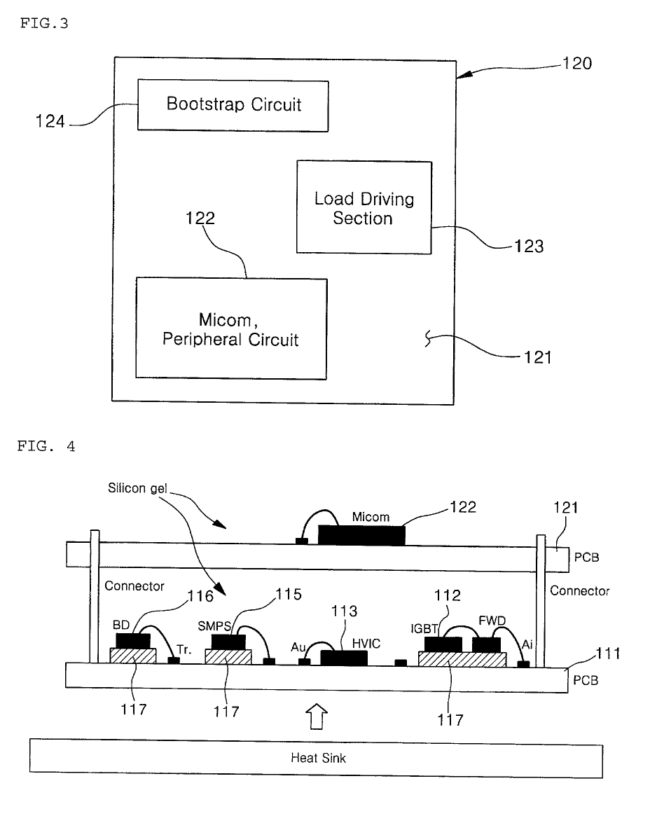

Referring to FIGS. 2 and 3, a single module system for an electric/electronic appliance in accordance with an embodiment of the present invention is constructed in such a way as to have a double-layered structure, thereby enabling a multitude of parts to be modularized.

In the double-layered structure of the single module system according to the present invention, exothermic devices are located on a first layer, and non-exothermic devices which constitute control-related parts, are located on a second layer. As a first PCB 111 which forms the first layer, a ceramic PCB, a metal PCB or the like having an excellent heat transfer characteristic is used.

In other words, as shown in FIG. 2, a first module section 110 which defines the first layer, includes an IGBT/FWD 112 constituting an inverter circuit portion, an IGBT gate drive 113, an IGBT protecting circuit 114 having an over-current (OC) portion and an over-temperature (TO) portion for protecting the IGBT which is susceptible to a pattern wiring, an SMPS switching transistor 115, and a bridge diode 116 serving as a rectifier. As described above, the IGBT/FWD 112, the IGBT gate drive 113, the IGBT protecting circuit 114, the SMPS switching transistor 115 and the bridge diode 116 which are exothermic devices, are disposed on the first PCB 111.

Further, as shown in FIG. 3, a second module section 120 which defines the second layer, includes a micom 122, a load driving portion 123, and a bootstrap circuit 124 for supplying device-driving power to an inverter circuit, which are disposed on a second PCB 121. Here, since the second layer does not include any exothermic device other than the first layer, the second layer is formed by the second PCB which is made of an epoxy or phenol-based material rather than a ceramic or metal-based material which is used to form the first layer.

Among devices which are used in the first and second layers, passive devices such as a resistor and a condenser are composed of surface-mounting device type parts. And, the IGBT, diode, transistor, micom and the like are composed of bare type parts and are connected to their respective PCBs through wire bonding.

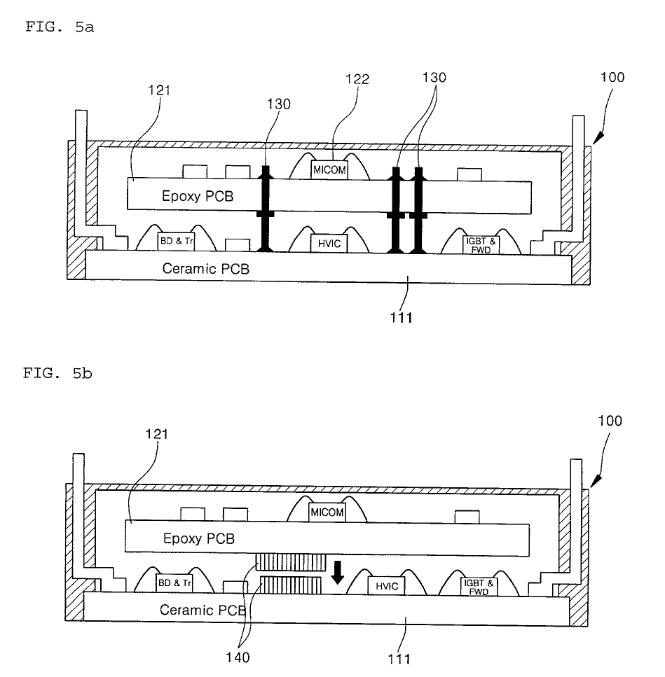

FIG. 4 is a cross-sectional view illustrating a double-layered arrangement of a power board and a control board of the single module system for an electric/electronic appliance according to the present invention.

Referring to FIG. 4, the respective exothermic devices composed of the bare type parts are located on the first PCB 111 which is made of the ceramic or metal-based material, and are connected to a pattern through wire bonding. At this time, the IBGT/FWD 112, the bridge diode 116 and the SMPS switching transistor 115 through which a great deal of current flows, are connected to the pattern through wire bonding using aluminum (Al), and an HVIC 113 for driving the IGBT is connected to the pattern through wire bonding using gold (Au).

Also, the micom 122 is located on the second PCB 121 which is made of the epoxy or phenol-based material and is connected to a pattern through wire bonding using aluminum (Al). At this time, due to the presence of the bare type parts on the first and second layers, silicon gel is used to encapsulate the bare type parts thereby to prevent the bare type parts from being oxidized in the air. The drawing reference numeral 117 represents heat spreaders which function to promote discharge of heat.

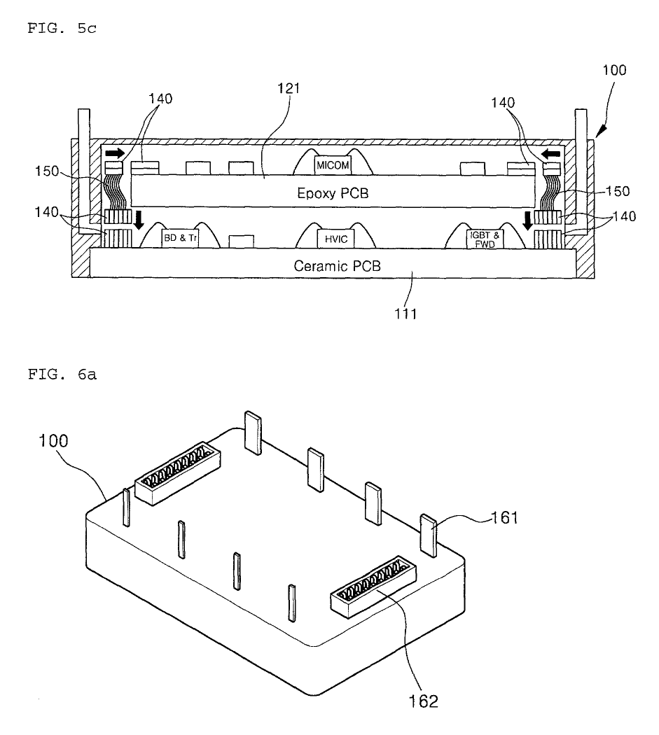

On the other hand, FIGS. 5a through 5c are cross-sectional views illustrating a variety of connection patterns between the power board and the control board in the single module system for an electric/electronic appliance according to the present invention.

FIG. 5a illustrates a structure in which the first and second layers are connected with each other through supporting bars 130. By this structure, it is possible to simultaneously accomplish connection between the first and second layers and support of the second layer without using separate members for supporting the second layer.

FIG. 5b illustrates another structure in which the first and second layers are connected with each other through sockets 140.

FIG. 5c illustrates still another structure in which the first and second layers are connected with each other by virtue of sockets 140 and jumper lines 150 to allow a connection operation in FIG. 5b to be implemented in an easier manner.

The single module system 100 which uses the connection structures between the first and second layers as shown in FIGS. 5a through 5c, must have pins for connecting the inverter to outside circuits or external loads, in consideration of an outside motor, an interface between a user and the electric/electronic appliance, and so on.

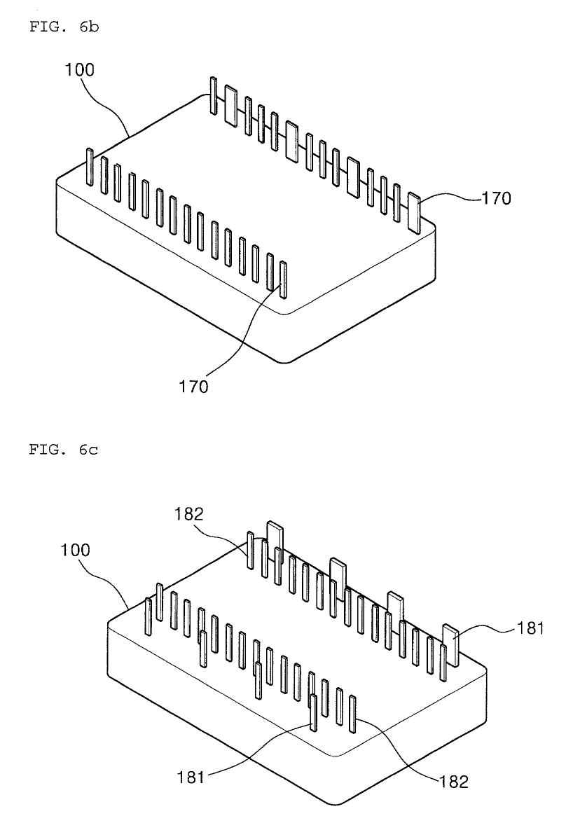

FIGS. 6a through 6c are perspective views illustrating a diversity of configurations of outside-connecting pins which are formed on an outer surface of the single module system for an electric/electronic appliance according to the present invention.

FIG. 6a illustrates a structure wherein an outer surface of the single module system 100 is provided with lead pins 161 which are connected to the first layer and IC socket-type connection pins 162 which are connected to the second layer. The lead pins 161 and the IC socket-type connection pins 162 are connected with the outside circuits or external loads.

FIG. 6b illustrates another structure wherein the outer surface of the single module system 100 is provided with first pins 170 which are connected with the first layer and second pins 170 which are connected with the second layer. The first and second pins 170 are respectively aligned in line one with another in such a way as to be connected with the outside circuits or external loads.

FIG. 6c illustrates still another structure wherein the outer surface of the single module system 100 is provided with first pins 182 which are connected with the first module section 110 and second pins 181 which are connected with the second module section 120. Since the first pins 182 are related with power supply, the first pins 182 are placed inward of the second pins 181. The first pins 182 and the second pins 181 are connected with the outside circuits or external loads.

As described above, by the single module system for an electric/electronic appliance, all circuit parts which are mounted on a PCB of the conventional inverter, can be modularized in a manner such that exothermic devices and non-exothermic devices are separately located on first and second layers, respectively. In the present invention, the first layer is formed of a material having an excellent heat transfer characteristic, such as a ceramic or metal-based PCB, so as to facilitate dissipation of heat which is generated by the exothermic devices, and the second layer is composed of an epoxy or phenol-based PCB. In order to further reduce a size of a module, the exothermic and non-exothermic devices comprise bare type parts. As a result, by the present invention, advantages are provided in that it is possible to realize a single modularized segment for a circuit of an electric home appliance employing an inverter. Furthermore, it is possible to develop an appliance which has merits in terms of a circuit size, an operational reliability and a manufacturing cost.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A single module system for an electric/electronic appliance, comprising:
a first module section having a first PCB which is made of a ceramic or metal-based material and exothermic devices which are located on the first PCB; and
a second module section having a second PCB which is made of an epoxy or phenol-based material and non-exothermic devices which are located on the second PCB.

2. The single module system as claimed in claim 1, wherein the first module section and the second module section are structured in a manner such that the first and second PCBs are connected with each other through and supported by supporting bars.

3. The single module system as claimed in claim 1, wherein the first module section and the second module section are structured in a manner such that the first and second PCBs are connected with each other by means of sockets.

4. The single module system as claimed in claim 3, wherein the first module section and the second module section are structured in a manner such that they are connected with each other via jumper lines each of which couples a socket of the first module section and a socket of the second module section with each other.

5. The single module system as claimed in any one of the claims 1 to 4, wherein an outer surface of the single module system is provided with lead pins for the first module section and IC socket-type connection pins for the second module section in such a way as to be connected with outside circuits or external loads.

6. The single module system as claimed in any one of the claims 1 to 4, wherein an outer surf ace of the single module system is provided with first pins which are connected with the first module section and second pins which are connected with the second module section, the first pins and second pins being respectively aligned in line one with another in such a way as to be connected with outside circuits or external loads.

7. The single module system as claimed in any one of the claims 1 to 4, wherein an outer surface of the single module system is provided with first pins which are connected with the first module section and second pins which are connected with the second module section, the first pins being placed inward of the second pins, the first pins and the second pins being connected with outside circuits or external loads.

8. The single module system as claimed in claim 1, wherein the exothermic devices and the non-exothermic devices comprise bare type parts.
